(19) United States
(12) Patent Application Publication
(10) Pub. No.: US 2009/0085305 A1
(43) Pub. Date: Apr. 2, 2009

(54) HIGH TEMPERATURE SEAL

(75) Inventors: Mehmet Demiroglu, Troy, NY (US); Christopher E. Wolfe, Niskayuna, NY (US); Patrick B. Melton, Horse Shoe, NC (US); Edip Sevincer, Scheneetady, NY (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/863,729

(22) Filed: Sep. 28, 2007

(51) Int. Cl. F16J 15/02

(52) U.S. Cl. 277/637

(57) ABSTRACT

An apparatus for sealing gas path leakage within a turbomachine is provided. The apparatus may include at least one seal system, which may include at least one sealing shim, at least one spring; and at least one shim protection material. The seal system may be inserted between a first and a second structure of the turbomachine. The seal system may adjust for misalignments between the first and the second structures of the turbomachine.

### BACKGROUND OF THE INVENTION

The present invention relates generally to turbomachines and, more particularly, to a seal system for controlling gas path leakage between turbomachine components.

Turbomachines (hereinafter “gas turbine”) include, but are not limited to, heavy-duty gas turbines and aero-derivative gas turbines. A gas turbine has a gas path, which typically includes, in serial-flow relationship, an air intake (or inlet), a compressor, a combustor, a turbine area, and a gas outlet (or exhaust nozzle). Gas leakage, either out of the gas path or into the gas path, from an area of higher pressure to an area of lower pressure is generally undesirable. For example, but not limiting of, gas path leakage in the turbine area of a gas turbine will lower the efficiency of the gas turbine leading to increased fuel costs. Also, gas path leakage in the combustor area of a gas turbine will require an increase in burn temperature to maintain power output, the increased burn temperature leads to increased NOx and CO emissions.

Gas path leakage typically occurs through gaps between gas turbine subassemblies such as through gaps between the combustor and the turbine, and gas path leakage occurs through gaps between the components that make up a gas turbine subassembly, such as through gaps between combustor casing segments. Such components and subassemblies have surfaces of different shapes, may suffer from assembly misalignment, and experience vibration. Hot-section components thermally experience hot gas flow and typically undergo different thermal growth rates.

One particular area where leakage may occur is the spacing between two gas turbine components such as adjacent vanes or ring segments. Sealing off this leakage path is problematic because the seal must be durable enough to withstand several thousand hours of operation and flexible enough to compensate for assembly misalignment, different engaging surfaces, vibration from operation, and unequal thermal expansion between adjacent components.

There are a few drawbacks with the currently known seal systems used to reduce such leakage. A conventional rigid or leaf seal system may allow for leakage flow from around the seal due to different surface shapes, assembly misalignment, vibration, thermal growth, and/or wear. Such leakage in the combustor may result in a 15 (or higher) parts-per-million (ppm) NOx production and a similar CO production. Conventional seal systems may not conform to the various misalignments; consequently, leakage occurs around the shims, which ultimately leads to a decrease in engine performance. Also, vibration and other relative movement of the adjacent components can wear the contact surfaces of the sealing shim, degrading sealing performance and introduce fracturing forces to the shim. Also, some seal systems experience high contact loads due to localized contact.

For the foregoing reasons, there is a need for an improved gas path leakage seal system for a gas turbine, which will increase efficiency and potentially decrease emissions, such as NOx and CO production. The seal system should be durable enough to withstand several thousand hours of operation. The seal system should also be flexible enough to compensate for assembly misalignment, different engaging surfaces, vibration from operation, and unequal thermal expansion between components. The seal system should also be able to withstand high contact loads due to localized contact.

### BRIEF DESCRIPTION OF THE INVENTION

In accordance with an embodiment of the present invention, an apparatus for controlling leakage comprising at least one seal system, wherein the at least one seal system comprises: at least one sealing shim comprising: a bridge portion comprising a top surface and a bottom surface; a first leg portion and a second leg portion; wherein and the bridge portion connects the first leg portion and the second leg portion, and wherein the first and second leg portions extend downward from the top surface at about 10 to about 60 degrees away from the bridge portion; at least one spring; shim protection material disposed between the first and second leg portions and substantially adjacent to a portion of the bottom surface of the bridge portion of the at least one sealing shim; and wherein the shim protection material and the at least one spring are secured to the at least one sealing shim.

In accordance with an alternate embodiment of the present invention a system for controlling leakage comprising: a first structure comprising a first recess, the first recess comprising a first top surface, a first bottom surface, and a first side surface; a second structure comprising a second recess, the second recess comprising a second top surface, a second bottom surface, and a second side surface, wherein the first recess is substantially aligned with the second recess; at least one seal system, wherein the at least one seal system comprises: at least one sealing shim comprising: a bridge portion comprising a top surface and a bottom surface; a first leg portion, a second leg portion, wherein and the bridge portion connects the first leg portion and the second leg portion; wherein the first and second leg portions extend downward from the top surface at about 10 to about 60 degrees away from the bridge portion; and wherein the first leg portion contacts the first side surface of the first recess and wherein the second leg portion contacts the second side surface of the second recess; at least one sheet of woven fibers disposed between the bottom surface of the at least one sealing shim and the first and second bottom surfaces of the first and second recesses, wherein the sheet of woven fibers are secured to the at least one sealing shim; and at least one spring comprising a first arm and a second arm; wherein a link portion connects the first arm and the second arm; wherein the first arm comprises a first arm radius and the second arm comprises a second arm radius; and wherein a portion of the first arm operatively contacts the first top surface of the first recess; and a portion of the second arm operatively contacts the second top surface of the second recess.

In accordance with a second alternate embodiment of the present invention a system an apparatus for controlling leakage comprising at least one seal system, wherein the at least one seal system comprises: at least one sealing shim comprising: a bridge portion comprising a top surface and a bottom surface; a first leg portion and a second leg portion; wherein and the bridge portion connects the first leg portion and the second leg portion, and wherein the first and second leg portions extend downward from the top surface at about 10 to about 60 degrees away from the bridge portion; at least one spring comprising a first arm portion and a second arm portion; wherein a link portion connects the first arm portion and the second arm portion; wherein the first arm portion comprises a first arm radius and the second arm portion comprises a second arm radius; wherein the link portion operatively contacts the top surface of the bridge portion of the at least one sealing shim; and shim protection material disposed between the first and second leg portions and substantially adjacent to a portion of the bottom surface of the bridge portion of the at least one sealing shim; and wherein the shim protection material and the at least one spring are secured to the shim.

In accordance with a third alternate embodiment of the present invention a system a system for controlling leakage comprising: a first structure comprising a first recess, the first recess comprising a first top surface, a first bottom surface and a first side surface; a second structure comprising a second recess, the second recess comprising a second top surface, a second bottom surface and a second side surface, wherein the first recess is substantially aligned with the second recess; at least one seal system, wherein the at least one seal system comprises: at least one sealing shim comprising: a bridge portion comprising a top surface and a bottom surface; a first leg portion, a second leg portion, wherein and the bridge portion connects the first leg portion and the second leg portion; wherein the first and second leg portions extend downward from the top surface at about 10 to about 60 degrees away from the bridge portion; and wherein the first leg portion contacts the first side surface of the first recess and wherein the second leg portion contacts the second side surface of the second recess; wherein the first leg portion of the at least one sealing shim comprises a first end portion, and the second leg portion of the at least one sealing shim comprises a second end portion; and wherein the first and second end portions each comprise a concave portion wherein an opening on each of the concave portions faces the at least one spring and extends to the first and second side surfaces of the first and second recesses; at least one sheet of woven fibers disposed between the bottom surface of the at least one sealing shim and the first and second bottom surfaces of the first and second recesses, wherein the sheet of woven fibers are secured to the at least one sealing shim; and at least one spring comprising a first arm and a second arm; wherein a link portion connects the first aim and the second arm; wherein the first arm comprises a first arm radius and the second arm comprises a second arm radius; and wherein a portion of the first arm operatively contacts the first top surface of the first recess; and a portion of the second arm operatively contacts the second top surface of the second recess.

In accordance with a fourth alternate embodiment of the present invention an apparatus for controlling leakage comprising at least one seal system, wherein the at least one seal system comprises: at least one sealing shim comprising: a bridge portion comprising a top surface and a bottom surface; at least one spring; shim protection material disposed substantially adjacent to a portion of the bottom surface of the bridge portion of the at least one sealing shim; and wherein the shim protection material and the at least one spring are secured to the at least one sealing shim.

### BRIEF DESCRIPTION OF THE DRAWINGS

FIG. 1 illustrates a cross-sectional view of a seal system in accordance with an embodiment of the present invention.

FIG. 2 illustrates a cross-sectional view of a seal system in accordance with an alternate embodiment of the present invention.

FIG. 3 illustrates a cross-sectional view of a seal system in accordance with a second alternate embodiment of the present invention.

FIG. 4 illustrates a cross-sectional view of a seal system in accordance with a third alternate embodiment of the present invention.

FIG. 5 illustrates a cross-sectional view of a seal system in accordance with a fourth alternate embodiment of the present invention.

### DETAILED DESCRIPTION OF THE INVENTION

Certain terminology is used herein for the convenience of the reader only and is not to be taken as a limitation on the scope of the invention. For example, words such as “upper,” “lower,” “left,” “right,” “front”, “rear” “top”, “bottom”, “horizontal,” “vertical,” “upstream,” “downstream,” “fore”, “aft”, and the like; merely describe the configuration shown in the Figures. Indeed, the element or elements of an embodiment of the present invention may be oriented in any direction and the terminology, therefore, should be understood as encompassing such variations unless specified otherwise.

The elements discussed herein may be connected, joined, fastened, or the like, via methods commonly used in the art. The embodiments of the present invention provide a gas path leakage seal system for use in a gas turbine.

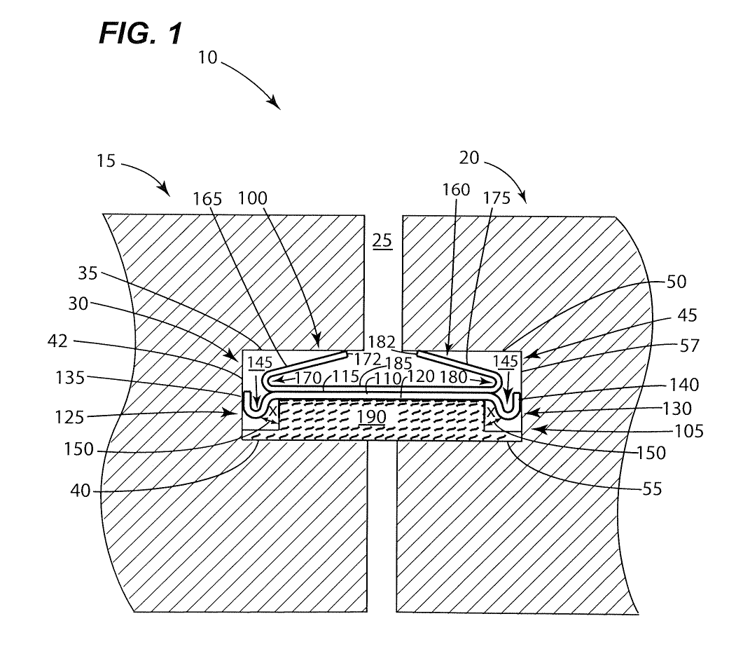

Referring now to the Figures, where the various numbers represent like elements throughout the several views, FIG. 1 illustrates a cross-sectional view of a seal system 100 in accordance with an embodiment of the present invention. FIG. 1 illustrates the seal system 100 within the gas turbine 10.

The gas turbine 10 may include a first and a second structure 15, 20. The first and second structures 15, 20 may be two separate turbine components, for example, but not limiting of, adjacent turbine vanes or adjacent turbine ring segments. Alternatively, the first and second turbine members 15, 20 may be two sections of the same component of the gas turbine 10.

The first and second structures 15, 20 may be spaced apart so as to define a gas leakage path 25.

The first structure 15 may include a first recess 30; the first recess 30 may include a first top surface 35, a first bottom surface 40, and a first side surface 42. Similarly, the second structure 20 may include a second recess 45; the second recess 45 may include a second top surface 50, a second bottom surface 55, and a second side surface 57. The first and second structures 15, 20 may be substantially aligned, allowing for receiving the seal system 100.

The seal system 100 may include at least one sealing shim 105; at least one spring 160; and shim protection material 190.

The sealing shim 105 may provide the main sealing surface of the seal system 100. The sealing shim 105 may be made of a metal, or any other material capable of withstanding the operating environment of the gas turbine 10, which the seal system 100 may experience. The sealing shim 105 may have a thickness of from about 5 mils to about 50 mils.

The sealing shim 105 may be generally planar and has a top surface 115 and a bottom surface 120. The sealing shim 105 may include three main portions: a first leg portion 125; a second leg portion 130; and a bridge portion 110 connecting the first and second leg portions 125, 130. As illustrated in FIG. 1, the bridge portion 110 may be substantially planar. The leg portions 125, 130 may originate near the ends of the bridge portion 110 and turn downward at an angle X 150 extending downward and away from the bridge portion 110, as illustrated in FIG. 1. The angle X 150 may be about 10 to about 60 degrees.

The first leg portion 125 may include a first end portion 135. Similarly, the second leg portion 130 may include a second end portion 140. The first and second end portions 135,140 may each include a concave portion 145 wherein an opening on each of the concave portions 145 face towards a portion of the at least one spring 160, as illustrated in FIG. 1. The radius of each concave portion 145 may be defined in part by the first and second end portions 135, 140 and the angle X 150. The radius of each concave portion 145 may be about 4 mils to about 10 mils. The concave portions 145 may aid in the sealing of the gas leakage path 25 by allowing the sealing shim 105 to contact the first and second side surfaces 42,57

The sealing shim 105 may have additional features depending in part on the manner in which other components of the seal system 100 cooperate with the sealing shim 105, as discussed below.

The seal system 100 may also include at least one spring 160. The at least one spring 160 may constantly urge the sealing shim 105 into contact with the first and the second structures 15, 20 and more particularly, with the first and second side surfaces 42, 57 of the first and second recesses 30, 45. The at least one spring 160 may be constructed, for example, but not limiting of from a spring steel or an other wear resistant material capable of withstanding the environment of the gas turbine 10, which the seal system 100 may experience. The spring 160 may be generally circular in cross-section. The at least one spring 160 may have a thickness of from about 3 mils to about 50 mils.

The spring 160 may include a first arm portion 165, a second arm portion 175, and a link portion 185 between, and connecting, the arm portions 165, 175.

A first arm radius 170 may join the first arm portion 165 with an end of the spring 160. Similarly, a second arm radius 180 may join the second arm portion 175 with an opposite end of the spring 160. In an embodiment of the present invention the first arm radius 170 and the second arm radius 180 may have a size allowing for a first arm end portion 172 to face a second arm end portion 182, and allowing for the second arm end portion 182 to face the first arm end portion 172; as illustrated in FIG. 1.

The first and second arm radius 170, 180 may be from about 10 mils to about 20 mils. In an alternate embodiment of the present invention, the first and second radius 170, 180 may be relatively large so as to increase the stiffness and range of travel of the spring 160.

The first and second arm radius 170, 180 may allow the spring 160 to easily adjust to a localized vibration, or the like, occurring on either structure 15, 20, which may result in a misalignment of the structures 15,20. The radius 170,180 may allow for either the first arm portion 165 or the second arm portion 175 to independently absorb a force transmitted from either the first or second top surfaces 35, 50 as may occur for example, but not limiting of, in a localized vibration, misalignment, or the like. Therefore, the first arm radius 170 allows for the first arm portion 165 to move independent of the second arm portion 175. Similarly the second arm radius 180 allows for the second arm portion 175 to move independent of the first arm portion 165.

The thickness of the spring 160 may generally be greater than the thickness of the sealing shim 105. Under non-operational conditions, the first and second arm portions 165, 175 may bend upwards from the link portion 185 at approximately the same angle; however, the arm portions 165, 175 may be at different relative elevations to accommodate the first and second top surfaces 35, 50 that each arm portion 165, 175 respectively engages. The link portion 185 may be substantially planar defining a single region of contact with the top surface 115 of the sealing shim 105. In an alternate embodiment of the present invention, the link portion may have another cross-sectional profile such that there are multiple points or areas of contact.

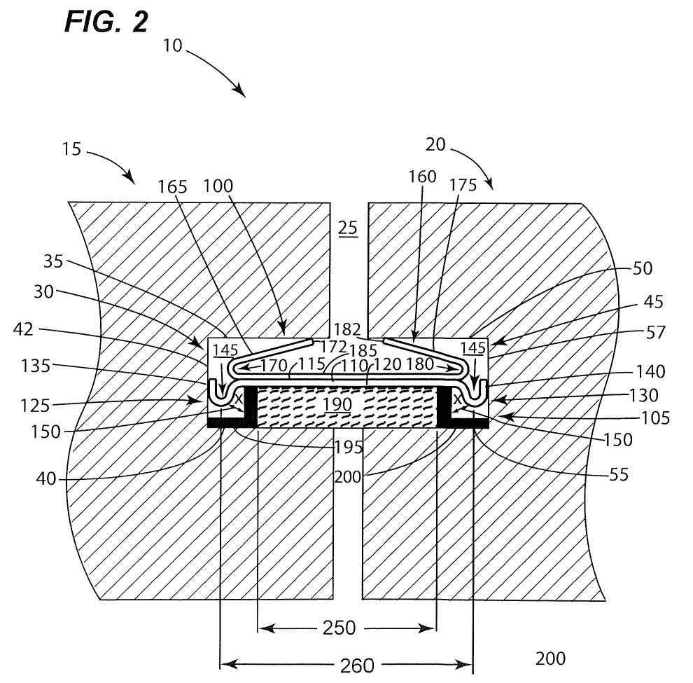

The first and second side surfaces 42, 57 of the first and second recesses 30, 45 as illustrated in FIGS. 1 and 2 may experience the highest temperature during the operation of the gas turbine 10. The material of the spring 160 may have a lower temperature threshold, before a thermal breakdown (or the like), than the material of the sealing shim 105. Therefore, in an embodiment of the present invention the overall width of the sealing shim 105 may be wider than the overall width of the spring 160. Here, for example, but not limiting of, the spring 105 may not engage the side portions of the first and second structures 15, 20 because the spring 160 may be fastened to the sealing shim 105.

The seal system 100 may also include shim protection material 190. The shim protection material 190 may provide a durable wear surface for contacting the first and second structures 15, 20 of the gas turbine 10. The shim protection material 190 may also provide secondary leakage resistance. The shim protection material 190 may be made of flexible interwoven fibers. The interwoven fibers may be made of for example, but not limiting of: cloth, metals, composites, ceramics, or combinations thereof.

The shim protection material 190 may include a single layer, wherein the fibers may be oriented in a single direction, at about 45 degrees with respect to the longitudinal direction of the sealing shim 105. In an alternate embodiment of the present invention the shim protection material 190 may include multiple layers (not illustrated), wherein the fibers may be alternatingly oriented. For example, but not limited of, the fibers of a first layer may be oriented at about 45 degrees whereas the fibers of an adjacent layer may be oriented at about 135 degrees. Moreover, the material compositions of each of the two layers may be identical or may be different relative to one another. Hence, the shim protection material 190 may composed of any material that may protect the sealing shim 105, provide a more durable wear surface, provides secondary leakage resistance, and may withstand the operational environment of a gas turbine 10.

The shim protection material 190 may be generally disposed adjacent to the bottom surface 120 of the sealing shim 105 between the first and second leg portion 125, 130. This placement may ensure that most of the bottom surface 120 of the sealing shim 105 may not contact the first and second structure 15, 20. The shim protection material 190 may be secured to the sealing shim 105 for example, but not limiting of, by spot welding or other fastening techniques.

Alternatively, the shim protection material 190 may be sufficiently long to extend between the end portions or leg portions 125, 130 of the sealing shim 105 so as to substantially abut the leg portions 125, 130. Then, the shim protection material 190 may be secured to each of the leg portions 125, 130 by a welding technique or other fastening technique, or the like.

Alternatively, for a more secure connection, the sealing shim 105 may be provided with a first rail 195 and an opposite second rail 200, which may extend downwardly from the bottom surface 120 of the bridge portion 110 of the sealing shim 105; as illustrated as an alternate embodiment of the present invention in FIG. 2. The rails 195, 200 may be spaced inward from the first and second end leg portions 125, 130. As a result, a first distance 250 may be defined between the rails 195, 200. This first distance 250 may be shorter than a second distance 260 defined between the first and second leg portions 125, 130 of the sealing shim 105. The shim protection material 190 may be sufficiently long to extend between and in substantial abutment with the rails 195, 200. After the shim protection material 190 is in place, the shim protection material 190 may be secured, for example, but not limiting of by welding, to each of the rails 195, 200.

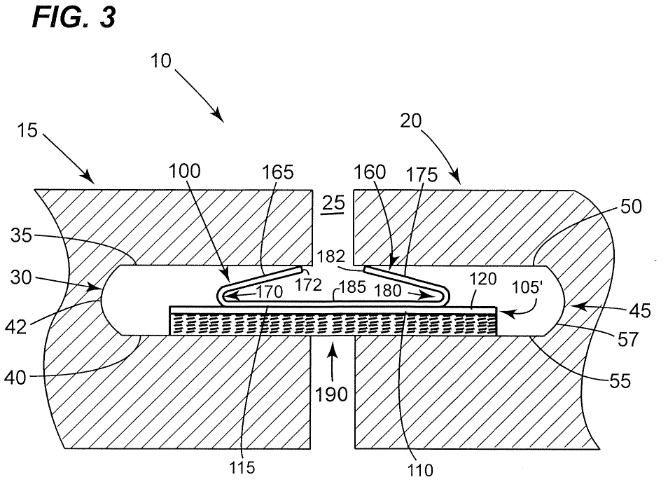

Referring to FIG. 3, which illustrates a cross-sectional view of a seal system 100 in accordance with a second alternate embodiment of the present invention. FIG. 3 illustrates an alternate embodiment of the sealing shim 105′. The primary difference between FIG. 3 and FIGS. 1-2, are the first and second leg portions 125,130. As illustrated in FIG. 3, the sealing shim 105′ does not include the first and second leg portions 125, 130. Otherwise the features and other relevant description of the seal shim 105, previously mentioned, may also be incorporated in the sealing shim 105′ illustrated in FIG. 3. The sealing shim 105′ may allow for example, but not limiting of, for insertion into a first and second structure 15, 20 having relatively smaller first and second recesses 30, 45.

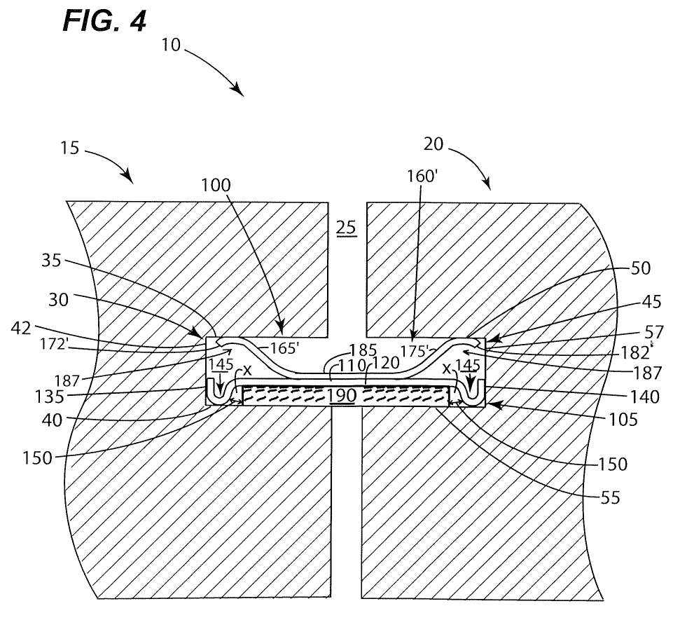

Referring now to FIG. 4, which illustrates a cross-sectional view of a seal system 100 in accordance with a third alternate embodiment of the present invention. The primary difference between FIG. 4 and FIGS. 1-2 is the overall shape of the spring 160. FIG. 4 illustrates an alternate embodiment of the spring 160′, which may include a first arm portion 165′, a second arm portion 175′, and a link portion 185 between, and connecting, the arm portions 165′, 175′.

As illustrated in FIG. 4 each of the arm portions 165′, 175′ may be connected to the link portion 185 in a manner wherein each arm portion 165′, 175′ bends away from the other arm portion 165′, 175′.

Each arm portion 165′, 175′ may include a spring concave portion 187. The spring concave portion 187 may allow for the arm portion 165′, 175′ to face downward towards each of the respective concave portions 145.

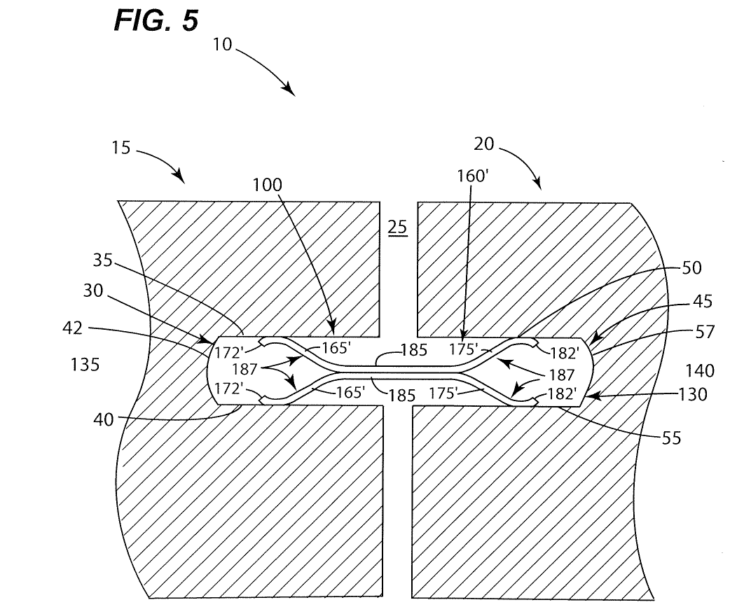

Referring now to FIG. 5, which illustrates a cross-sectional view of a seal system 100 in accordance with a fourth alternate embodiment of the present invention. The primary difference between FIG. 5 and FIG. 4 is the replacement of the sealing shim 105 with a second spring 160′. As illustrated in FIG. 5, two springs 160′ may form the seal system 100. The two springs 160′ may be inserted into the first and second structures 15, 20 in an opposite orientation. As illustrated in FIG. 5, after insertion each spring 160′ may appear as a mirror image of the other spring 160′.

The configuration of the first and second structure 15, 20 may determine the degree of bend used on each of the first and second arm portions 165′, 175′ when formed with the respective link portions 185.

This fourth alternate embodiment of the present invention may include shim protection material 190 (not illustrated in FIG. 5) connected to the top spring 160′, the bottom spring 160′, or both springs 160′. The shim protection material 190 may be connected as previously described.

The elements of the embodiments of the seal system 100 of the present invention may be assembled in the following manner. After identifying a gas leakage path 25 between the first and second structures 15, 20; first and second recesses 30, 45 are added in the first and second structures 15, 20; if necessary. The shim protection material 190 may be secured to the bottom surface 120 of the sealing shim 105, 105′ in the manner described above. The sealing shim 105, 105′ and shim protection material 190 may then be placed into the recesses 30, 45 of the structures 15, 20.

Next, the first and second end leg portions 125, 130 of the sealing shim 105 engage the respective first and second side surfaces 42, 57 of the recesses 30, 45. In addition, the shim protection material 190 may be substantially adjacent to the bottom surfaces 40, 55 of the recesses 30, 45. Next, the at least one spring 160 may be inserted into the recesses 30, 45 between the first and second top surfaces 35, 50 of the recesses 30, 45 and the top surface 115 of the sealing shim 105, 105′. When in position, the link portion 185 of the spring 160 operatively acts against the top surface 115 of the bridge portion 110 of the sealing shim 105, 105′. Concurrently the first and second arm portions 165, 175 of the spring 160 operatively act against the first and second top surfaces 35, 50 of the recesses 30, 45 in the first and second structures 15, 20.

The spring 160, may be inwardly biased so that the sealing shim 105 and shim protection material 190 are urged downward against the first and second bottom surfaces 40, 55 of the recesses 30, 45 in the first and second structures 15, 20.

In addition to preventing gas path mixing, the seal system 100 may accommodate misalignment of the first and second structures 15, 20 of the gas turbine 10 due to thermal loads or vibration because the spring 160 may be resilient enough to accommodate elevational variations. For example, but not limiting of, if the first structure 15 is jolted such that the recesses 30, 45 no longer align vertically, then the spring 160 may compensate for the changed conditions. The first and second radius 170, 180 of the first and second arm portions 165, 175, may be at different elevations. Moreover, on the first and second bottom surfaces 40, 55 of the recesses 30, 45, the fibers comprising the shim protection material 190 may be flexible enough to conform to various thermal and mechanical misalignments experienced by the components of the gas turbine 10.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although the present invention has been shown and described in considerable detail with respect to only a few exemplary embodiments thereof, it should be appreciated that any arrangement that we do not intend to limit the invention to the embodiments since various modifications, omissions and additions may be made to the disclosed embodiments without materially departing from the novel teachings and advantages of the invention, particularly in light of the foregoing teachings. Accordingly, we intend to cover all such modifications, omission, additions and equivalents as may be included within the spirit and scope of the invention as defined by the following claims.

What is claimed is:

1. An apparatus for controlling leakage comprising at least one seal system, wherein the at least one seal system comprises:
at least one sealing shim comprising
a bridge portion comprising a top surface and a bottom surface;
a first leg portion and a second leg portion; wherein and the bridge portion connects the first leg portion and the second leg portion, and wherein the first and second leg portions extend downward from the top surface at about 10 to about 60 degrees away from the bridge portion;
at least one spring;
shim protection material disposed between the first and second leg portions and substantially adjacent to a portion of the bottom surface of the bridge portion of the at least one sealing shim; and
wherein the shim protection material and the at least one spring are secured to the at least one sealing shim.

2. The apparatus of claim 1, wherein the at least one spring comprises a first arm portion and a second arm portion; wherein a link portion connects the first arm portion and the second arm portion;
wherein the first arm portion comprises a first arm radius and the second arm portion comprises a second arm radius; and
wherein the link portion operatively contacts the top surface of the bridge portion of the sealing shim.

3. The apparatus of claim 1, wherein the first leg portion of the at least one sealing shim comprises a first end portion, and the second leg portion of the at least one sealing shim comprises a second end portion; and wherein the first and second end portions each comprise a concave portion wherein an opening on each of the concave portions faces the at least one spring and extends to the side of the recess into which the seal apparatus fits.

4. The apparatus of claim 1, wherein the at least one sealing shim further comprises a first rail portion and an opposite second rail portion; wherein the first and second rail portions extend downward from the bottom surface of the bridge portion; and wherein the shim protection material extends between and substantially adjacent to the first and second rail portions and is secured thereto.

5. The apparatus of claim 1, wherein the shim protection material comprises woven fibers.

6. The apparatus of claim 2, wherein the first arm radius allows for the first arm portion to move independently of the second arm portion, and wherein the second arm radius allows for the second arm portion to move independently of the first arm portion.

7. The apparatus of claim 3, wherein an overall width of the at least one sealing shim is greater than an overall width of the at least one spring.

8. The apparatus of claim 6, wherein the first arm radius allows for a first arm end portion of the first arm to face a second arm end portion of the second arm; and wherein the second arm radius allows for the second arm end portion to face the first arm end portion.

9. A system for controlling leakage comprising:
a first structure comprising a first recess, the first recess comprising a first top surface, a first bottom surface, and a first side surface;
a second structure comprising a second recess, the second recess comprising a second top surface, a second bottom surface, and a second side surface, wherein the first recess is substantially aligned with the second recess;
at least one seal system, wherein the at least one seal system comprises:
at least one sealing shim comprising:
a bridge portion comprising a top surface and a bottom surface;
a first leg portion, a second leg portion, wherein and the bridge portion connects the first leg portion and the second leg portion;
wherein the first and second leg portions extend downward from the top surface at about 10 to about 60 degrees away from the bridge portion; and
wherein the first leg portion contacts the first side surface of the first recess and wherein the second leg portion contacts the second side surface of the second recess;
at least one sheet of woven fibers disposed between the bottom surface of the at least one sealing shim and the first and second bottom surfaces of the first and second recesses, wherein the sheet of woven fibers are secured to the at least one sealing shim; and
at least one spring comprising a first arm and a second arm; wherein a link portion connects the first arm and the second arm;
wherein the first arm comprises a first arm radius and the second arm comprises a second arm radius; and
wherein a portion of the first arm operatively contacts the first top surface of the first recess; and a portion of the second arm operatively contacts the second top surface of the second recess.

10. The system of claim 9, wherein said first and second structures are adjacent turbomachine components.

11. The system of claim 9, wherein the first arm portion of the at least one spring comprises a first arm radius and the second arm portion of the at least one spring comprises a second arm radius; and wherein the link portion of the at least one spring operatively contacts the top surface of the bridge portion of the sealing shim.

12. The system of claim 11, wherein the at least one spring is positioned such that the link portion operatively contacts the top surface of the bridge portion of the at least one shim; and the first arm and the second arm portions of the at least one spring operatively contact the first and second top surfaces of the first and second recesses.

13. The system of claim 9, wherein the sheet of woven fibers comprises a single layer.

14. The system of claim 9, wherein the sheet of woven fibers comprises at least two layers.

15. The system of claim 11, wherein the first arm radius allows for the first arm portion to move independently of the second arm portion, and wherein the second arm radius allows for the second arm portion to move independently of the first arm portion.

16. The system of claim 9, wherein an overall width of the at least one sealing shim is greater than an overall width of the at least one spring.

17. The system of claim 9, wherein the first arm radius allows for a first arm end portion of the first arm to face a second arm end portion of the second arm; and wherein the second arm radius allows for the second arm end portion to face the first arm end portion.

18. The system of claim 9, wherein the at least one sealing shim further comprises a first rail portion and an opposite second rail portion; wherein the first and second rail portions extend downward from the bottom surface of the bridge portion; and wherein the shim protection material extends between and substantially adjacent to the first and second rail portions and is secured thereto.

19. The system of claim 9, wherein the first leg portion comprises a first end portion and the second leg portion comprises a second end portion; and wherein the first and second end portions each comprise a concave portion wherein an opening on each of the concave portions faces the at least one spring.

20. An apparatus for controlling leakage comprising at least one seal system, wherein the at least one seal system comprises:
at least one sealing shim comprising:
a bridge portion comprising a top surface and a bottom surface;
a first leg portion and a second leg portion; wherein and the bridge portion connects the first leg portion and the second leg portion, and wherein the first and second leg portions extend downward from the top surface at about 10 to about 60 degrees away from the bridge portion;
at least one spring comprising a first arm portion and a second arm portion;
wherein a link portion connects the first arm portion and the second arm portion;
wherein the first arm portion comprises a first arm radius and the second arm portion comprises a second arm radius;
wherein the link portion operatively contacts the top surface of the bridge portion of the at least one sealing shim; and
shim protection material disposed between the first and second leg portions and substantially adjacent to a portion of the bottom surface of the bridge portion of the at least one sealing shim; and
wherein the shim protection material and the at least one spring are secured to the shim.

21. A system for controlling leakage comprising:
a first structure comprising a first recess, the first recess comprising a first top surface, a first bottom surface and a first side surface;
a second structure comprising a second recess, the second recess comprising a second top surface, a second bottom surface and a second side surface, wherein the first recess is substantially aligned with the second recess;
at least one seal system, wherein the at least one seal system comprises:
at least one sealing shim comprising:
a bridge portion comprising a top surface and a bottom surface;
a first leg portion, a second leg portion, wherein and the bridge portion connects the first leg portion and the second leg portion;
wherein the first and second leg portions extend downward from the top surface at about 10 to about 60 degrees away from the bridge portion; and
wherein the first leg portion contacts the first side surface of the first recess and wherein the second leg portion contacts the second side surface of the second recess;
wherein the first leg portion of the at least one sealing shim comprises a first end portion, and the second leg portion of the at least one sealing shim comprises a second end portion; and
wherein the first and second end portions each comprise a concave portion wherein an opening on each of the concave portions faces the at least one spring and extends to the first and second side surfaces of the first and second recesses; at least one sheet of woven fibers disposed between the bottom surface of
the at least one sealing shim and the first and second bottom surfaces of the first and second recesses, wherein the sheet of woven fibers are secured to the at least one sealing shim; and
at least one spring comprising a first arm and a second arm; wherein a link portion connects the first arm and the second arm;
wherein the first arm comprises a first arm radius and the second arm comprises a second arm radius; and
wherein a portion of the first arm operatively contacts the first top surface of the first recess; and a portion of the second arm operatively contacts the second top surface of the second recess.

22. An apparatus for controlling leakage comprising at least one seal system, wherein the at least one seal system comprises:
at least one sealing shim comprising:
a bridge portion comprising a top surface and a bottom surface;
at least one spring;
shim protection material disposed substantially adjacent to a portion of the bottom surface of the bridge portion of the at least one sealing shim; and
wherein the shim protection material and the at least one spring are secured to the at least one sealing shim.

23. The apparatus of claim 22, wherein the at least one spring comprises a first arm portion and a second arm portion; wherein a link portion connects the first arm portion and the second arm portion;
wherein the first arm portion comprises a first arm radius and the second arm portion comprises a second arm radius; and
wherein the link portion operatively contacts the top surface of the bridge portion of the sealing shim.

24. The apparatus of claim 22, wherein the shim protection material comprises woven fibers.

25. The apparatus of claim 23, wherein the first arm radius allows for the first arm portion to move independently of the second arm portion, and wherein the second arm radius allows for the second arm portion to move independently of the first arm portion.

26. The apparatus of claim 22, wherein an overall width of the at least one sealing shim is greater than an overall width of the at least one spring.

27. The apparatus of claim 23, wherein the first arm radius allows for a first arm end portion of the first arm to face a second arm end portion of the second arm; and wherein the second arm radius allows for the second arm end portion to face the first arm end portion.
